(19) United States
(12) Patent Application Publication
(10) Pub. No.: US 2016/0209135 A1
(43) Pub. Date: Jul. 21, 2016

(54) LANCE APPARATUS

(71) Applicants: Brad R. Moring, Allen, TX (US); Sonia K. Moring, Woodinville, WA (US); Greg Peck, Summersvile, SC (US)

(72) Inventors: Brad R. Moring, Allen, TX (US); Sonia K. Moring, Woodinville, WA (US); Greg Peck, Summersvile, SC (US)

(21) Appl. No.: 14/601,710

(22) Filed: Jan. 21, 2015

(51) Int. Cl. F28G 15/02; B08B 9/032

(52) U.S. Cl. CPC F28G 15/02; B08B 9/0321

(57) ABSTRACT

Disclosed is a lance apparatus for cleaning the tubes of a tube bundle. The apparatus comprises a gantry adapted to be snugly and rotably secured to an annular flange such that, the gantry rotates over the flange as supported by the flange, the gantry comprising at least one elongate guide, a support member receiving the at least one guide therethrough such that, the support member slides along the length of the at least one guide, the rotary motion of the gantry imparted to the support member, and a carriage for receiving at least one lance therethrough, which, in turn, is to be introduced into one or more tubes, the carriage supported by the support member such that, the rotary motion of the support member is not imparted to the carriage.

### BACKGROUND

### Field of the Invention

The present invention relates lance apparatuses employed for cleaning tube bundles of heat exchangers, more particularly, to automated lance apparatuses that negates or at least minimizes human intervention, and even more particularly to a novel automated lance apparatus that is adapted to be secured to the flange of the heat exchanger itself.

Tube bundles of heat exchangers, to begin with, are enormous in size resulting in severely constraining the mobility thereof for maintenance purposes. Therefore, for maintenance of the tube bundles, it has to be the maintenance equipment that needs to be brought to the location of the tube bundle. Lance cleaning of the tube bundles is one of the common periodic maintenances associated with tube bundles. This involves advancing flexible or rigid tubes (called lances) into the tube bundle while they discharge high-pressure fluid whereby, unwanted deposits accumulated within the tubes are flushed out.

The lance apparatuses known in the art have more or less the follow a structure comprising a lance-feeding carriage that slides along the length of a horizontal track support and the horizontal support slides vertically along the length of usually a pair of vertical track supports. This matrix-type arrangement basically ensures the coverage of the entire cross-sectional face of the tube bundle. Few drawbacks of this type of apparatus include: complexity of the apparatus, the necessity to manually adjust the distance between the tube bundle cross-sectional face and the apparatus every time the apparatus is set up and the lot of time that takes up in setting up this type of an apparatus.

A simpler, easier, lance apparatus would be a welcome addition to the art.

### SUMMARY

The present invention comprises a lance apparatus that is designed to be easily secured to the annular flange of the tube bundle itself as opposed to being set up on the floor. This approach, from the outset, takes care of the long-felt issue of manually needing to adjust the distance between the tube bundle and the lance apparatus.

The apparatus comprises a gantry comprising a pair of flange clamps, one of which secured at one end of two vertically-aligned guides, while the other is clamp is free to be secured at any point along the length of the guides so as to accommodate various sized tube bundle faces. Each clamp comprises a pair of opposingly-disposed side rollers, the axis of each of which is parallel front flange surface. The width of the flange is to be snugly held between the pair of side rollers. A knob is provided to adjust the distance between the side rollers so as to achieve a snug-fit between the side rollers and the width of the flange. Each clamp further comprises a pair of top rollers that straddle the pair of side rollers. The top rollers are adapted to roll over the outer circumferential edge of the flange as the width of the flange is snugly held between the side rollers. Diametrically, the flange is snugly held between the two pairs of top rollers as the distance between the clamps, as mentioned earlier, is adjustable. The top rollers are driven by a servo motor such that, when one motor (of a clamp) rotates a pair of top rollers in clockwise direction, the other motor (of the other clamp) rotates the other pair of top rollers in the opposite counter-clockwise direction (in the same speed of rotation) thereby enabling the gantry to rotate over the flange as supported by it.

The apparatus further comprises a lance-feeding carriage disposed between the two clamps as the carriage is configured to slide over the guides. The combination of the rotation of the gantry combined with the sliding of the carriage over the guides ensures the coverage of the entire cross-sectional face of the tube bundle.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a perspective view of the lance apparatus.

FIG. 2, according to an embodiment of the present invention, is an illustration of a perspective view of the tube bundle.

FIG. 3, according to an embodiment of the present invention, is an illustration of the lance apparatus secured to a tube bundle.

FIG. 4, according to an embodiment of the present invention, is an illustration of a perspective view of the annular flange.

FIG. 5, according to an embodiment of the present invention, is an illustration of a perspective view of the gantry.

FIG. 6, according to an embodiment of the present invention, is an illustration of an exploded perspective view of the gantry.

FIG. 7, according to an embodiment of the present invention, is an illustration of a perspective view of the top guide.

FIG. 8, according to an embodiment of the present invention, is an illustration of a perspective view of a flange clamp.

FIG. 9, according to an embodiment of the present invention, is an illustration of the annular flange held between the pair of side rollers.

FIG. 10, according to an embodiment of the present invention, is an illustration of a perspective view of a support member.

FIG. 11, according to an embodiment of the present invention, is an illustration of the carriage being received within the carriage receptacle.

FIG. 12, according to an embodiment of the present invention, is an illustration of the lance plate being received within the lance plate receptacle.

FIG. 13, according to an embodiment of the present invention, is an illustration of a perspective view of a lance plate.

FIG. 14, according to an alternate embodiment of the present invention, is an illustration of an exploded perspective view of the lance plate.

FIG. 15, according to an embodiment of the present invention, is an illustration of a perspective view of the carriage.

FIG. 16, according to an embodiment of the present invention, is an illustration of a sectional perspective view of the carriage.

FIG. 17, according to an additional embodiment of the present invention, is an illustration of a perspective view of the annular flange stand.

FIG. 18, according to an additional embodiment of the present invention, is an illustration of the annular flange stand used in conjunction with a tube bundle.

### FIGURES-REFERENCE NUMERALS

10—Lance Apparatus
12—Tube
14—Tube Bundle
16—Annular Flange
18F—Front Annular Surface
18R—Rear Annular Surface
20O—Outer Circumferential Edge Surface
20I—Inner Circumferential Edge Surface
22—Flange Opening
24—Gantry
26—Support Member
28—Carriage
30T—Top Elongate Guide
30B—Bottom Elongate Guide
32F—Fixed Flange Clamp
32M—Mobile Flange Clamp
34—Teeth Surface
36T—Top Guide Hole
36B—Bottom Guide Hole
38—Clamp Lock
40—Side Roller
42—Knob
44—Top Roller
46—Servo Motor
48—Conveyer Belt
50—Base Section
52—Carriage Receptacle
54—Low Friction Roller
56—Lance
58—Lance Plate Receptacle
60—Lance Plate
62—Lance Hole
64—Gear Rollers
66—Base Plate
67—Fastener
68—Ring gear
70—Ingress Roller
72—Drive Gear
74—Flange Stand

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

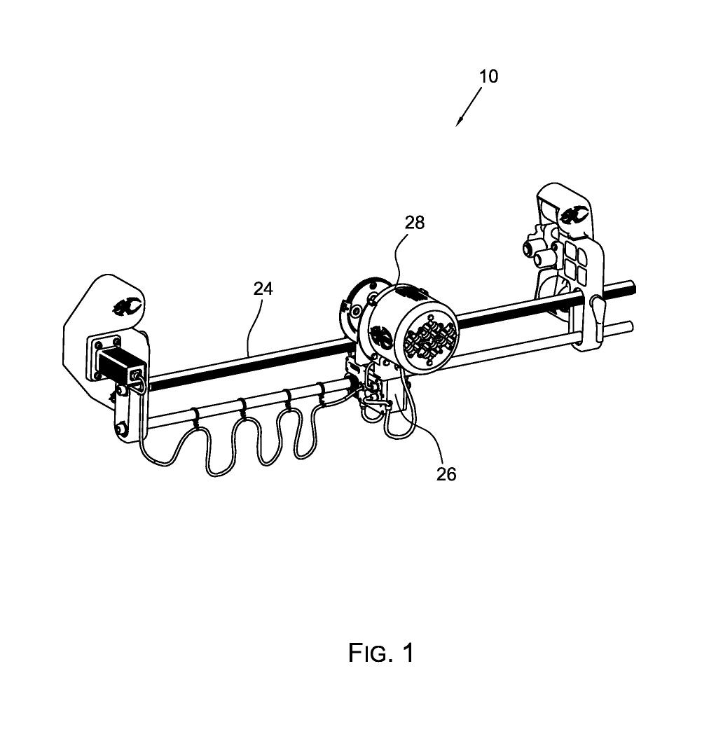

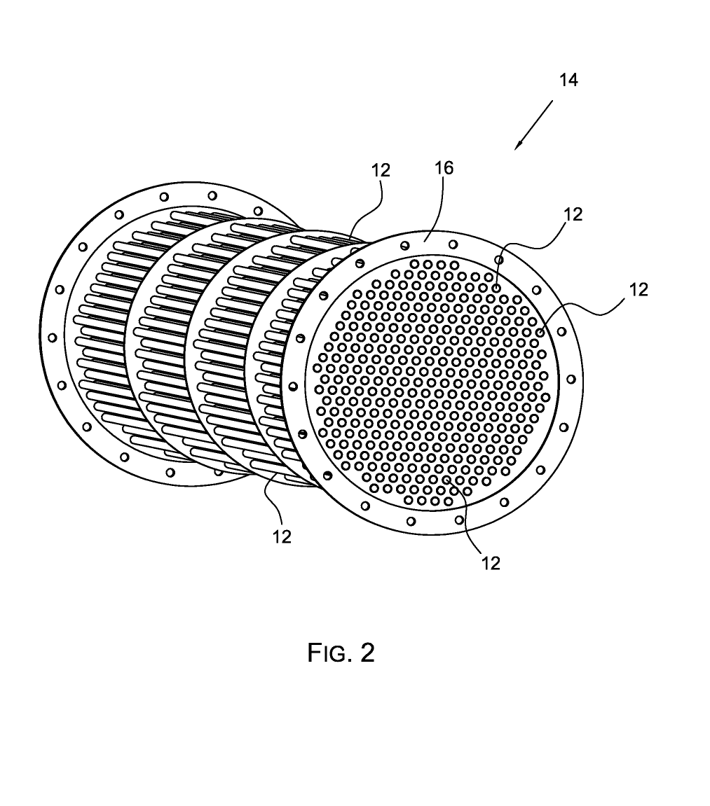

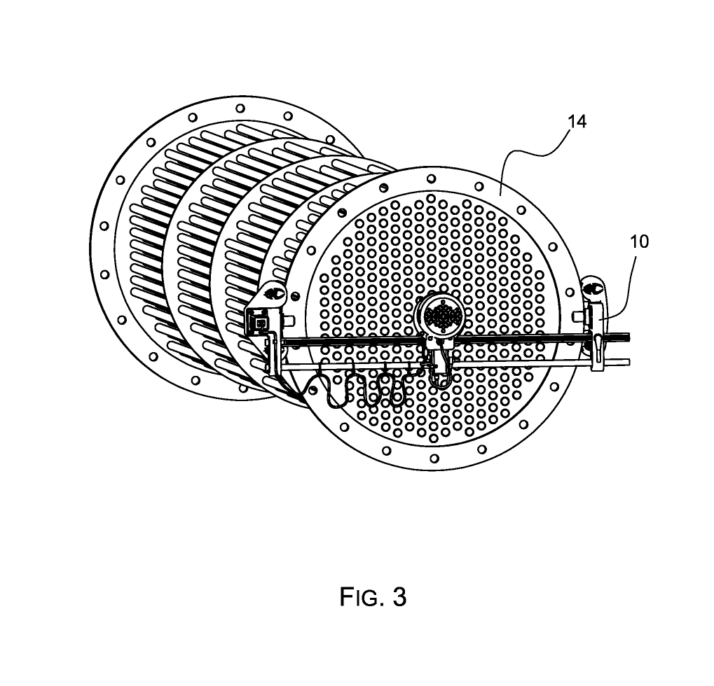

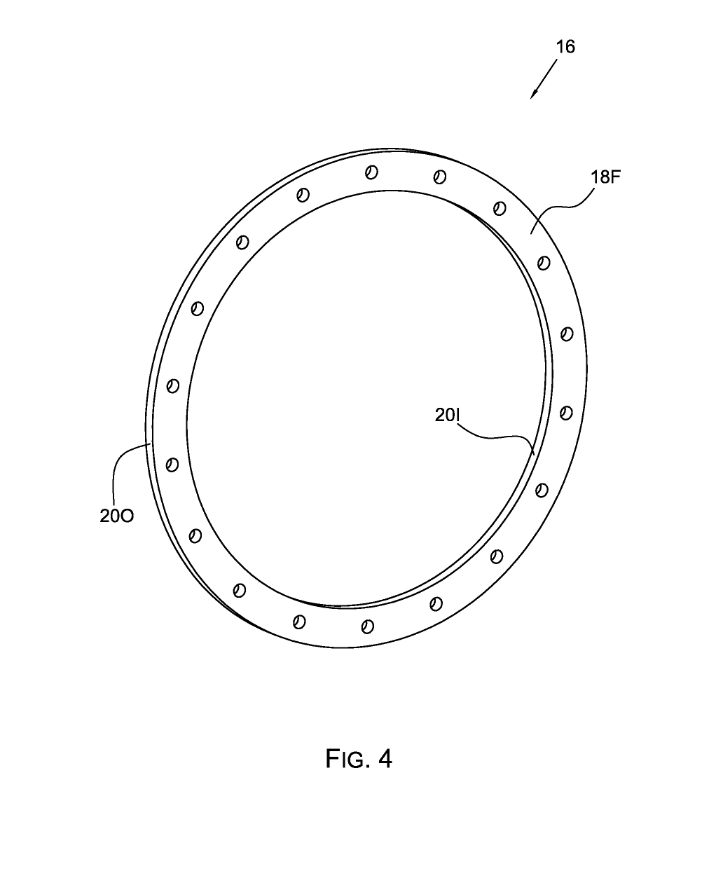

Referring to FIGS. 1 through 4, the present invention comprises a lance apparatus 10 employed for cleaning the tubes 12 of a heat exchanger tube bundle 14. In a preferred embodiment of the present invention, the lance apparatus 10 is adapted to be secured to the annular flange 16 of the tube bundle 14 itself as shown in FIG. 3. The annular flange 16 comprises front and rear annular vertical surfaces 18F and 18R that are perpendicular to the tubes 12 and outer and inner circumferential edge surfaces 20O and 20I that are parallel to the tubes 12. The opening of the flange 22 (bordered by the inner circumferential edge 20I) spans the cross-sectional face of the tube bundle 14. The lance apparatus 10 comprises three primary components, viz., a gantry 24, a support member 26, and a cylindrical carriage 28 wherein, each of which will be discussed in detail in the following body of text.

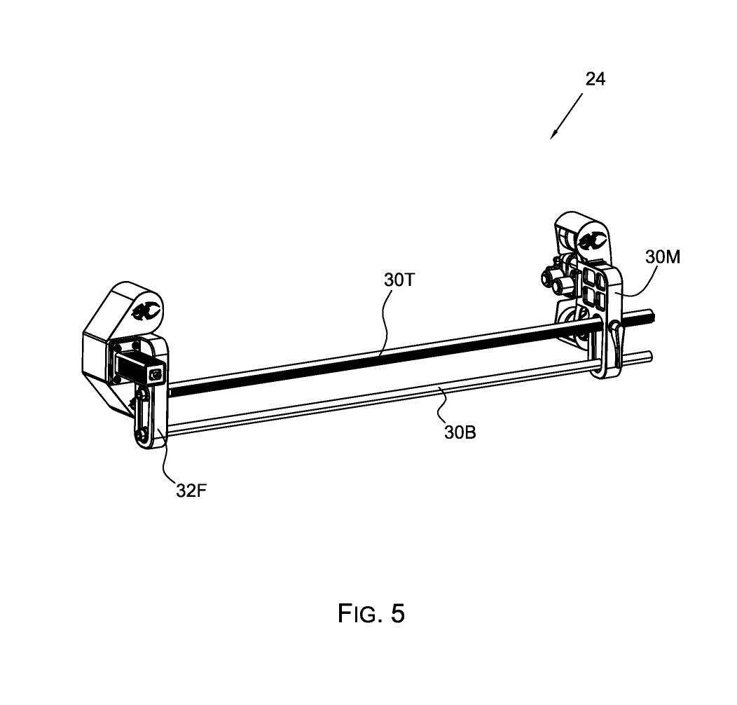

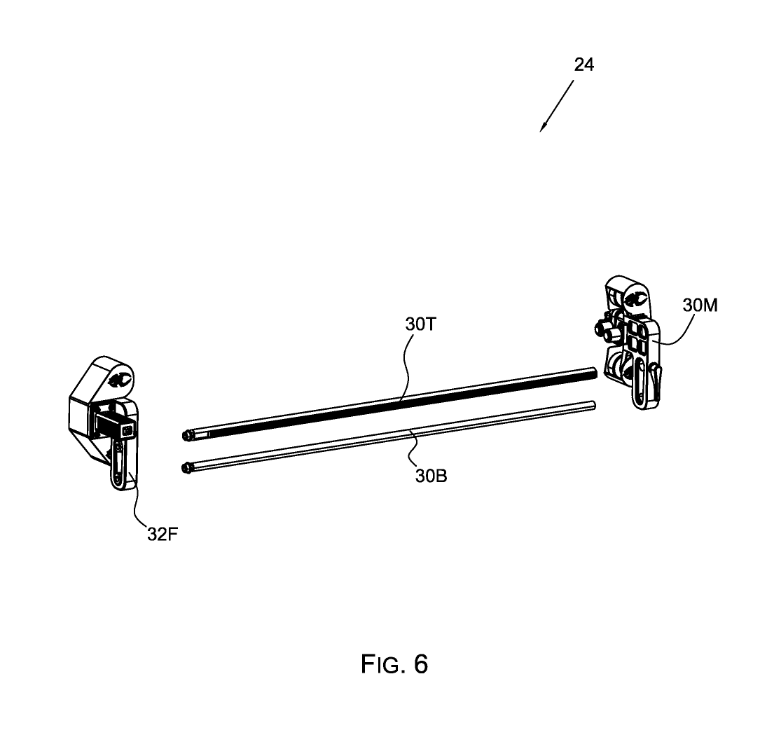

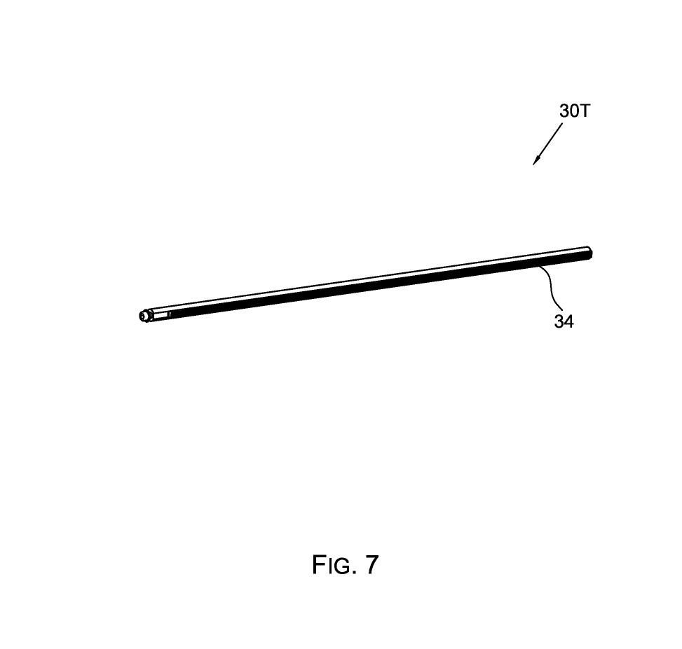

Referring to FIGS. 5 through 7, the gantry 24 comprises vertically-aligned top and bottom elongate guides 30T and 30B and a pair of flange clamps 32 wherein, the pair of clamps 32 are adapted to be secured to either end portion of the guides 30T and 30B. The top guide 30T comprises rod of uniform, uniform circular cross-section except for the inclusion of a flat, elongate, longitudinal teeth surface 34 spanning almost the entire length thereof. The utility of the teeth surface 34 will become apparent from the following body of text. The bottom guide 30B, on the other hand, as can be appreciated from the referred drawings, simply comprises a rod of uniform circular cross-section.

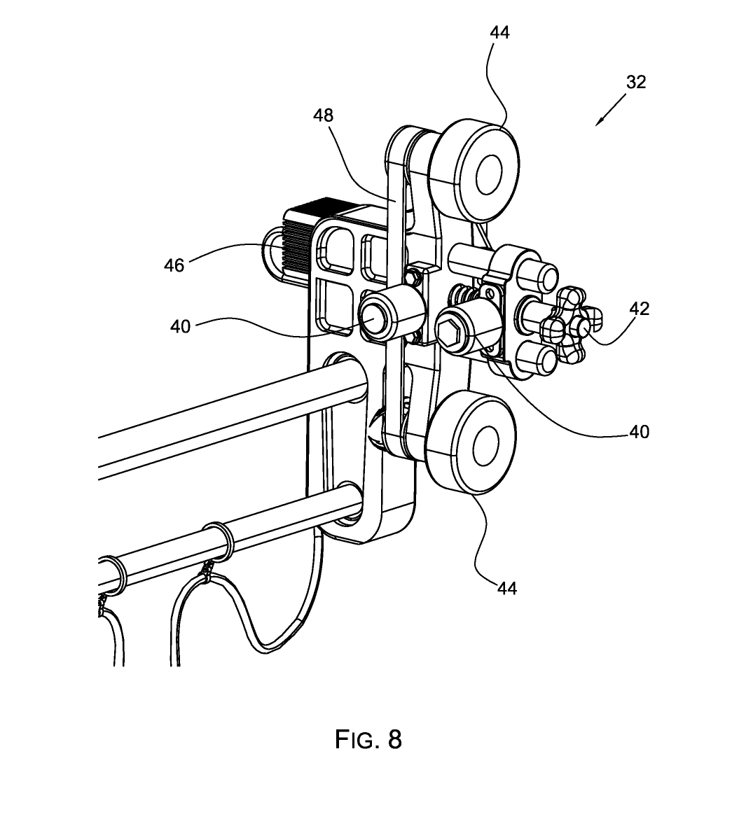

Referring to FIGS. 5, 6 and 8, the pair of clamps 32 comprises a fixed clamp 32F and a mobile clamp 32M. Each of the clamps 32 comprises a pair of vertically-aligned top and bottom guide holes 36T and 36B for receiving the top and bottom guides 30T and 30B respectively therethrough. While the fixed clamp 32F is secured at one end of the guides 30, the mobile clamp 32M is adapted to be secured at any point along the length of the guides 22. More particularly, the mobile clamp 32M comprises a clamp lock 38, which when manually deployed, engages the teeth surface 34 at which point, the mobile clamp 32M is locked thereat.

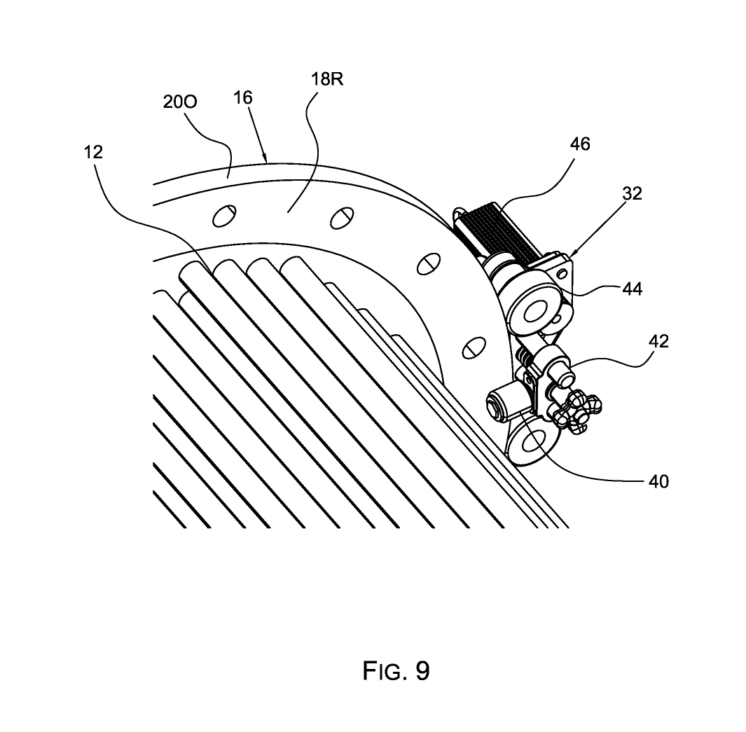

Referring to FIGS. 3, 8 and 9, each clamp 32 further comprises a pair of opposingly-disposed side rollers 40, the axis of each of which lies perpendicular to the tubes 12 upon the clamp 32 being secured to the flange 16. The width of the flange 16 is to be snugly held between the pair of side rollers 40 such that, one side roller 40 abuts and rolls over the front surface 18F, while the other side roller 40 abuts and rolls over the rear surface 18R. Each clamp 32 further comprises a knob 42 for manually adjusting the distance between the pair of side rollers 40 so as to achieve the snug-fit between the side rollers 40 and the flange 16. Each clamp 32 further comprises a pair of top rollers 44 that straddle the pair of side rollers 40. The top rollers 44 are adapted to roll over the outer circumferential edge 20O of the flange 16 as the width of the flange 16 is snugly held between the side rollers 40. Diametrically, the flange 16 is snugly held between the two pairs of top rollers 44 as the distance between the fixed and mobile clamps 32F and 32M is adjustable. As can be appreciated from the referred drawings, the top rollers 44 are driven by a servo motor 46 via a conveyer belt 48. More particularly, the motors 46 are configured such that, when one motor 46 rotates a pair of top rollers 44 in clockwise direction, the other motor 46 rotates the other pair of top rollers 44 in the opposite counter-clockwise direction (in the same speed of rotation) thereby enabling the gantry 24 to rotate over the flange 16 as supported by it.

Referring to FIGS. 1, 3, and 10, the support member 26 comprises a substantially rectangular base section 50 and a carriage receptacle 52, which is supported by the base section 50. A pair of top and bottom guide holes 36T and 36B are disposed at the rear of the base section 50 for enabling the top and bottom guides 30T and 30B to pass therethrough such that, the support member 26 slides along the length of the guides 30 limited by the pair of clamps 32. The sliding of the support member 26 is electrically powered, thereby enabling the support member 26 to slide over the guides 30 even in the event of the guides 30 being vertically oriented. More particularly, the sliding of the support member 26 is powered by one or more electrical devices disposed within a rectangular housing disposed afore the pair of top and bottom guide holes 36T and 36B thereof.

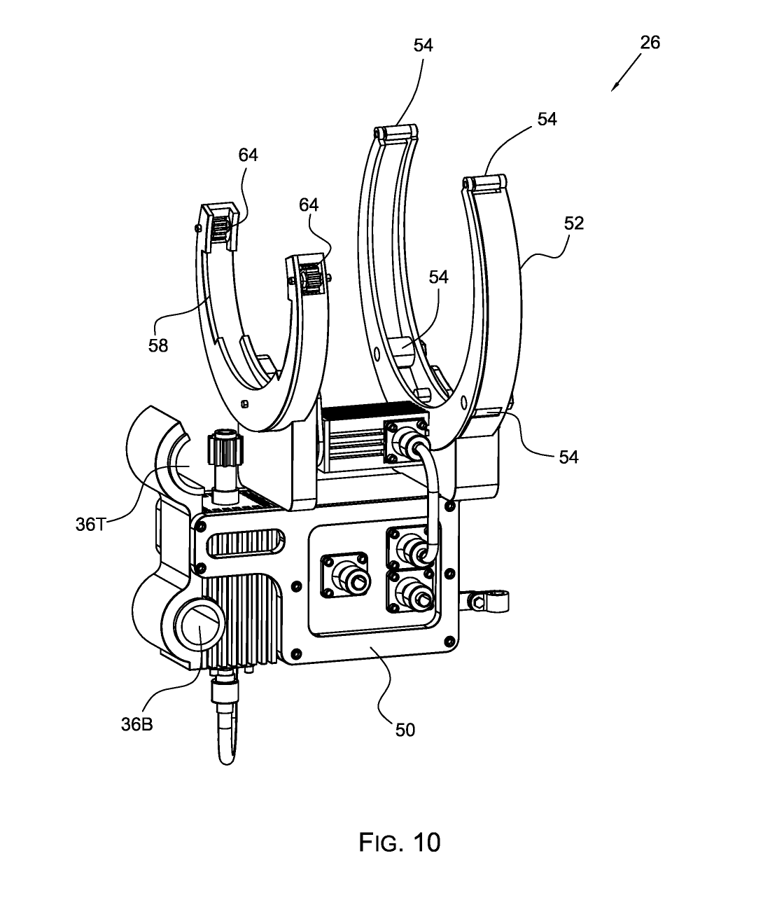

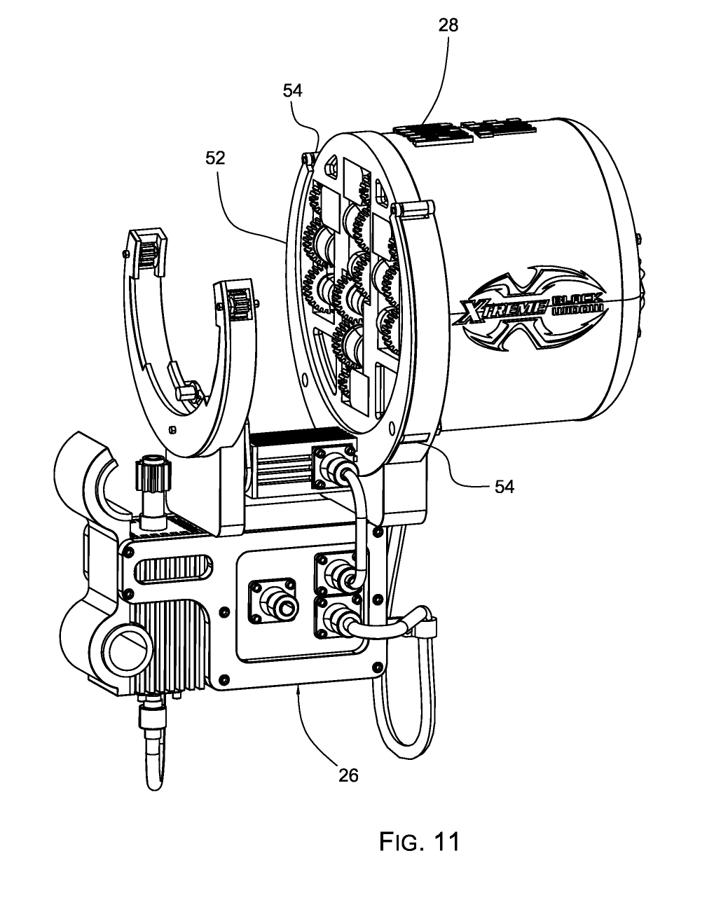

Referring to FIGS. 10 and 11, the support member 26 further comprises a carriage receptacle 52 for receiving the carriage 28 therewithin wherein, the carriage receptacle 52 comprises a substantially semi-annular member. The inner annular edge surface of the carriage receptacle 52 is lined with a plurality of low friction rollers 54, the axis of each of which being parallel to the tubes 12. As the cylindrical carriage 28 is received within the carriage receptacle 52, the cylindrical surface contour of the carriage 28 conforms to the groove of the carriage receptacle 52 at which point, the low friction rollers 54 come into contact therewith. At this point, as the rotary motion of the gantry 24 is imparted to the support member 26, owing to the employment of the low friction rollers 54, the rotary motion of the support member 26 is not imparted to the carriage 28 thus not eventually subjecting the lances 56 received through the carriage 28 to torsion.

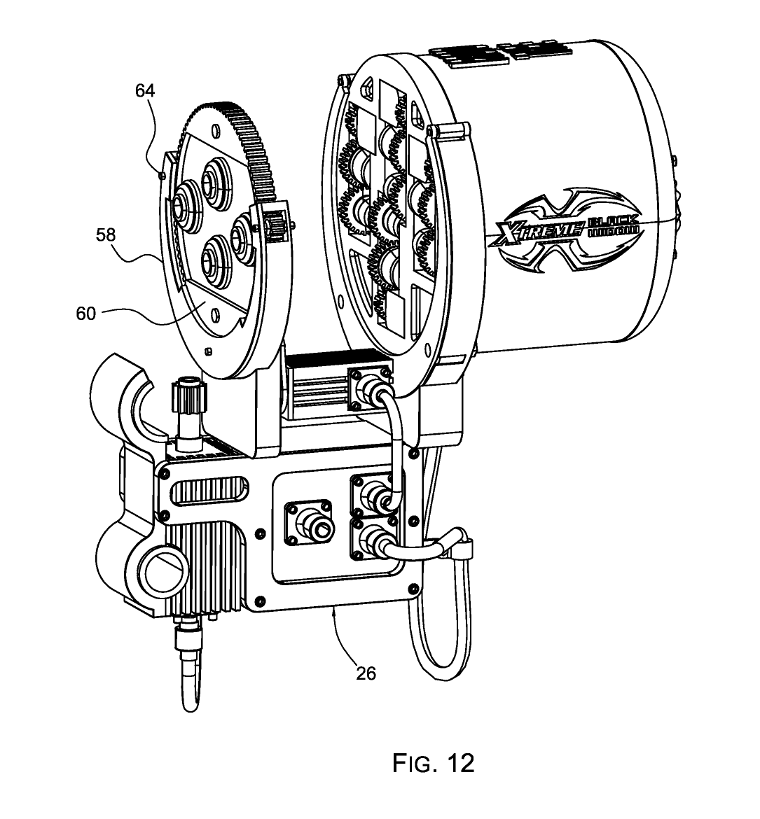

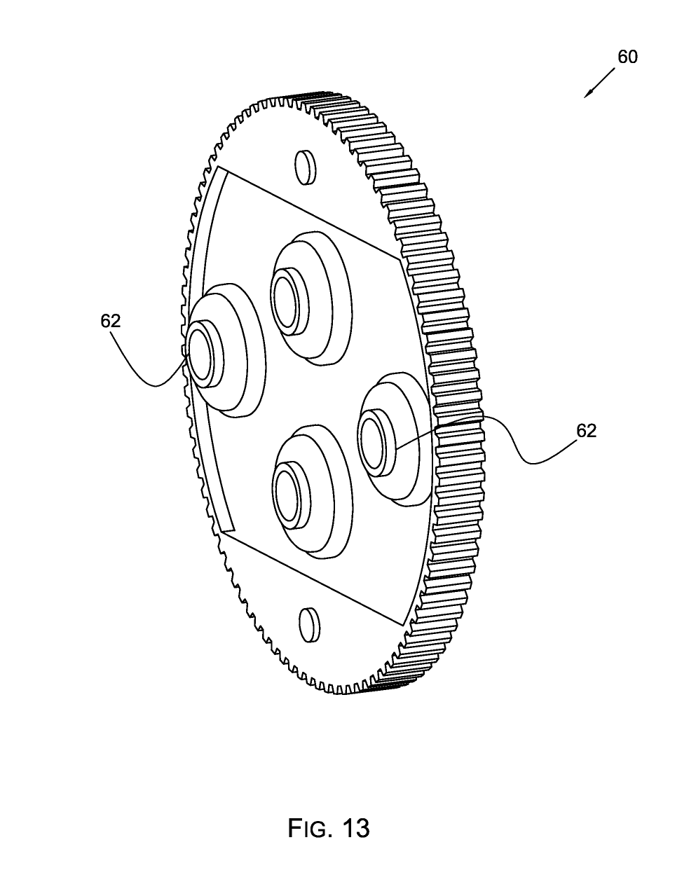

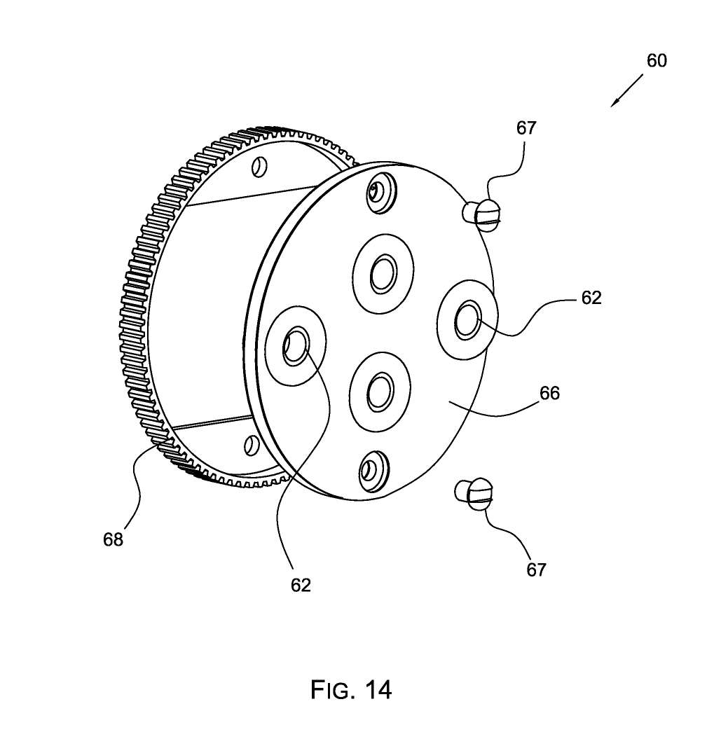

Referring to FIGS. 10 through 13, the support member 26 further comprises a lance plate receptacle 58 for receiving a circular lance plate 60 therewithin wherein, the lance plate 60 acts as an auxiliary member of the carriage 28. More particularly, the lance plate 60 comprises four lance holes 62 disposed thereon for receiving four lances 56 therethrough. Further, the lance plate 60, similar to a gear wheel, comprises a plurality of teeth disposed on the circumference thereof wherein, the utility of the teeth will become apparent from the following body of text. The lance plate 60 receptacle, similar to a carriage receptacle 52, comprises a substantially semi-annular member. The inside of the extremities of the lance plate receptacle 58 is attached with a two opposingly-disposed gear rollers 64, the axis of each of which being parallel to the tubes 12. As the lance plate 60 is received within the lance plate receptacle 58, the gear rollers 64 come into contact with circumference of the lance plate 60. Therefore, as the rotary motion of the gantry 24 is imparted to the support member 26, owing to the employment of the gear rollers 64, the rotary motion of the support member 26 is not imparted to the lance plate 60 thus eventually not subjecting the lances 56 received through the lance plate 60 to torsion. In one embodiment, as seen in FIG. 14, the lance plate 60 comprises an assemblage of a circular base plate 66 with the four lance holes 62 disposed thereon and a ring gear 68 wherein, the base plate 66 upon being snugly received within the ring gear 68 is secured thereto by means of fasteners 67 to form the lance plate 60.

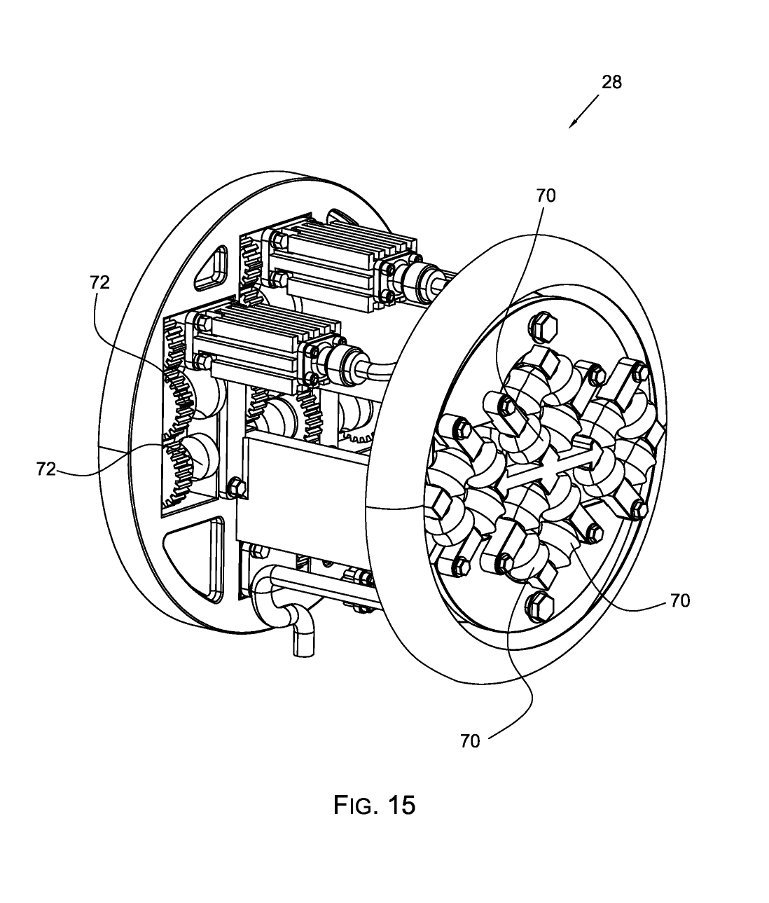

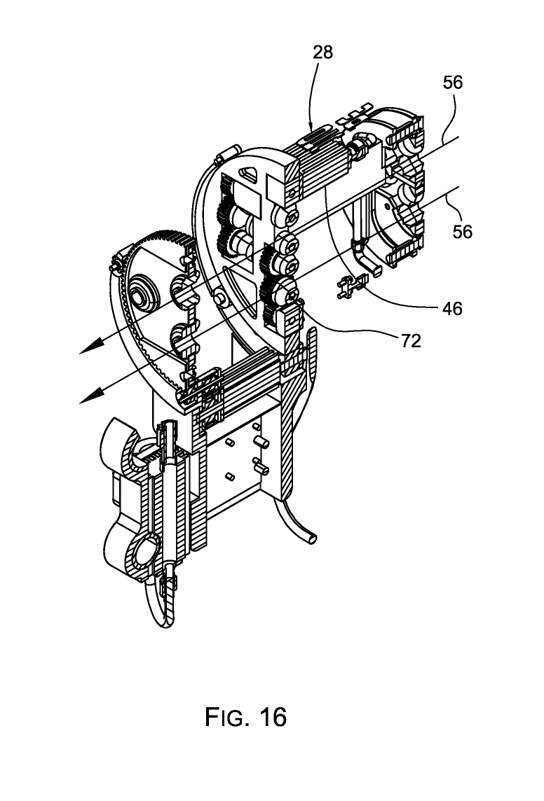

Referring to FIGS. 1, 3, 15 and 16, the cylindrical carriage 28 comprises front are rear circular surfaces and a lance drive system disposed therebetween. Each of the front and rear surfaces comprises four lance holes such that, a lance hole on the front surface aligns with the lance hole on the rear surface. The circumferential edge of each lance hole on the front surface is lined with a four ingress rollers 70 for easing the ingress of the lance 56 therethrough. The lance drive system comprises four pairs of drive gears 72, each of which for advancing or retracting a lance 56 received therethrough. Notably, as can be appreciated from the referred drawings, each drive gear 72 pair is driven by a servo motor 46. Each drive gear 72 of a drive gear pair comprises a cylindrical member with a longitudinal portion thereof comprising gear teeth and another longitudinal portion adjacent to the earlier longitudinal portion comprising a groove. As the pair of drive gears 72 mesh with one another, the grooves thereof collectively form a substantially circular orifice for receiving a lance 56 therethrough. The lance 56 passing through the corresponding drive gear 72 eventually egresses through the corresponding lance hole on the rear surface of the carriage 28 so as to be advanced into or retracted from the assigned tube 12 thereafter depending on the direction of the rotation of the drive gears 72.

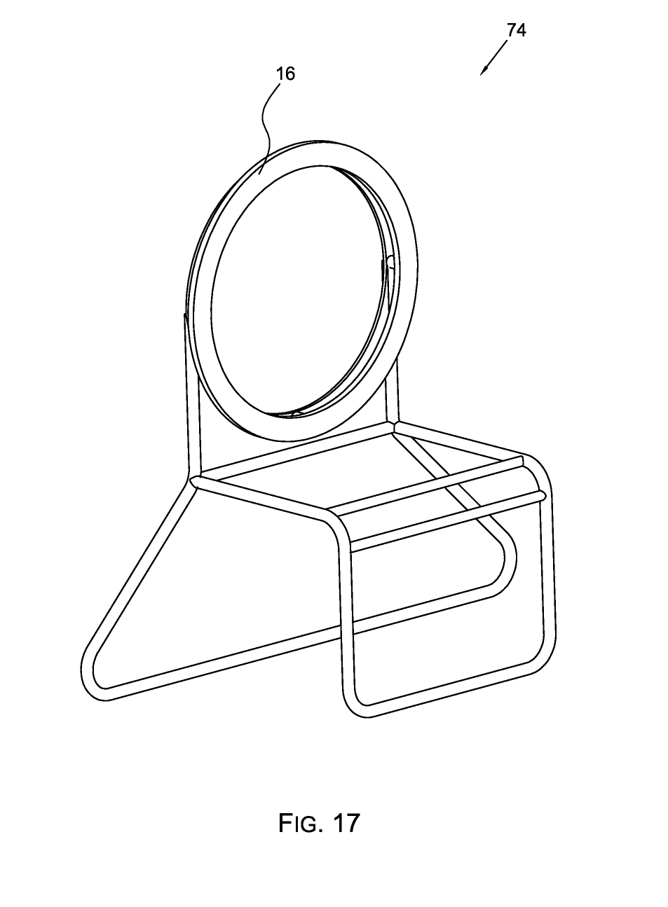

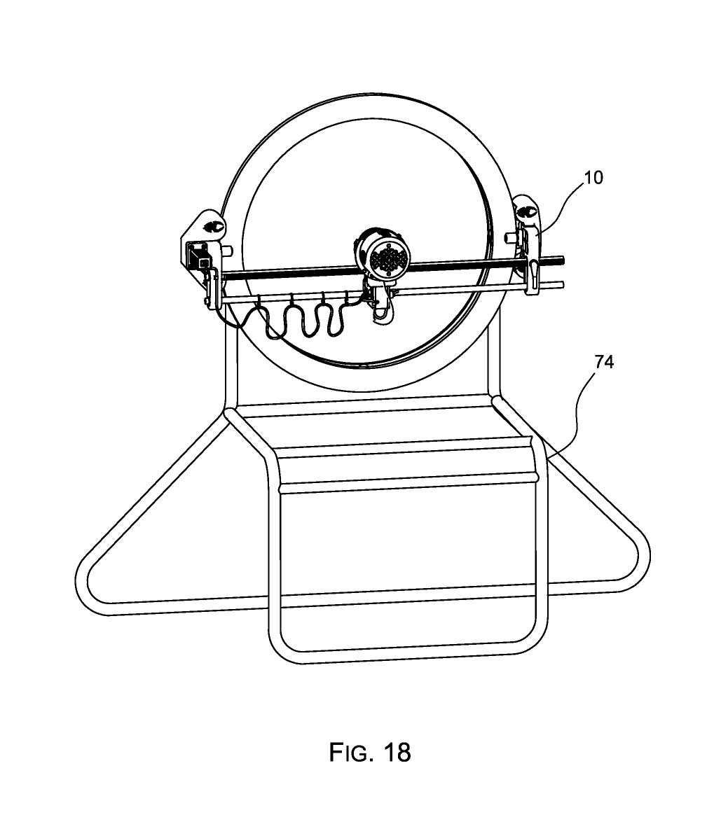

Referring to FIGS. 17 and 18, in one embodiment, the lance apparatus 10 is secured to the annular flange 16 of a flange stand 74 instead of being secured to the annular flange 16 of a tube bundle 14. The flange stand 74 comprises a frame structure, the shape of which resembles a chair (with a backrest) wherein, the annular flange 16 thereof is secured on top the backrest. In one embodiment, the annular flange 16 is adapted to be height-adjustable so as to be in keeping with the elevation of the tube bundle 14 off the ground.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. For example, the protective case assembly can be adapted to accommodate a tablet PC by simply altering the dimensions thereof. However, all such modifications are deemed to be within the scope of the claims.

1. A lance apparatus for cleaning the tubes of a heat exchanger tube bundle, the apparatus comprising:
(a) a gantry adapted to be snugly and rotably secured to an annular flange such that, the gantry rotates over the flange as supported by the flange, the gantry comprising at least one elongate guide, the annular flange comprising front and rear vertical surfaces and an outer circumferential edge surface, the front and rear surface of the annular flange being perpendicular to the tubes;
(b) a support member receiving the at least one guide therethrough such that, the support member slides along the length of the at least one guide, the rotary motion of the gantry imparted to the support member; and
(c) a carriage for receiving at least one lance therethrough, which, in turn, is to be introduced into one or more tubes, the carriage supported by the support member such that, the rotary motion of the support member is not imparted to the carriage;
wherein, rotation of the gantry coupled with the to and fro movement of the carriage ensure the complete coverage of the face of the tube bundle.

2. The apparatus of claim 1 wherein, the gantry comprises a pair of spaced-apart opposingly-disposed flange clamps, the clamps secured to the at least one guide at substantially either end thereof as the at least one guide is received therethrough, each clamp comprising:
(a) a pair of opposingly-disposed side rollers, one of which adapted to roll over the front vertical surface of the flange, while the other adapted to roll over the rear vertical surface of the flange as the front and rear surfaces of the flange are snugly held between the side rollers, the distance between the side rollers adapted to be adjustable, the axis of each side roller being perpendicular to the tubes; and
(b) a pair of top rollers straddling the pair of side rollers, each top roller adapted to roll over the outer circumferential edge surface of the flange, the axis of each top roller being parallel to the tubes wherein, on account of the side rollers snugly abutting the front and rear sides of the flange, the motion from top rollers is imparted to the side rollers.

3-8. (canceled)

9. The apparatus of claim 2 wherein, each clamp further comprises at least one guide hole, the clamp is received over the at least one guide as the at least one guide is received through the at least one guide hole.

10. (canceled)

11. The apparatus of claim 2 wherein, each clamp further comprises a cover for covering over the pair of top rollers.

12. The apparatus of claim 2 wherein, the support member is slidably disposed between the pair of clamps as the at least one guide is received therethrough.

13. The apparatus of claim 12 wherein, the support member comprises:
(a) at least one guide hole for receiving the at least one guide therethrough; and
(b) a carriage receptacle for receiving the carriage therewithin such that, the rotary motion of the carriage receptacle is not imparted to the carriage.

14. The apparatus of claim 13 wherein, the at least one guide hole comprises two vertically-aligned guide holes.

15. (canceled)

16. (canceled)

17. The apparatus of claim 13 wherein, the carriage receptacle comprises a substantially semi-annular member, which is adapted to snugly receive the carriage, which is cylindrical in shape, within the groove thereof wherein, as the carriage is received within the carriage receptacle, the exterior curved surface of the cylindrical carriage conforms to inner curved surface of the carriage receptacle; the surface of the cylindrical carriage abuts the surface of carriage such that, the rotary movement of the carriage receptacle is not imparted to the carriage.

18. The apparatus of claim 17 wherein, the inner surface of the carriage receptacle is lined with a plurality of rollers, which are adapted to roll over outer curved surface of the carriage whereby, the rotary motion of the carriage receptacle is not imparted to the carriage.

19. The apparatus of claim 13 wherein, the support member further includes a substantially semi-annular lance plate receptacle for receiving a circular lance plate within the groove thereof such that, the circular edge of the lance plate conforms to the inner curved surface of the lance plate receptacle; the rotary motion of the guide plate receptacle not imparted to the lance plate.

20. The apparatus of claim 19 wherein, the inner surface of the lance plate receptacle is lined with a plurality of rollers, which are adapted to roll over the circumferential edge of the lance plate whereby, the rotary motion of the lance plate receptacle is not imparted to the lance plate.

21. The apparatus of claim 20 wherein, each roller comprises gear teeth that meshes with gear teeth disposed on the circumference of the lance plate.

22. (canceled)

23. (canceled)

24. The apparatus of claim 2 wherein, the flange is snugly and diametrically held between the pair of flange clamps.

25. The apparatus of claim 1 wherein, the carriage comprises a substantially cylindrical structure comprising:
(a) front and rear circular surfaces, each of which comprising at least one lance hole such that, each of the at least one lance hole on the front surface corresponds with a lance hole on the rear surface, a lance received through the carriage as is received through the corresponding lance holes of the first and rear surfaces; and
(b) a lance drive system disposed between the front and rear surfaces for advancing or retracting each lance received through the carriage into or from a tube respectively.

26. The apparatus of claim 25 wherein, a lance received through the lance hole on the front surface is guided by a plurality of lance rollers, the lance hole circumference lined with the plurality of lance rollers; the axis of each lance roller being perpendicular to the lance.

27. The apparatus of claim 25 wherein, the lance drive system comprises at least one pair of drive gears, each of which for advancing or retracting a lance, each drive gear of a drive gear pair comprising a cylindrical member, a longitudinal portion of which comprises a gear teeth, another longitudinal portion of which comprises a circumferential groove wherein, as a pair of drive gears mesh with one another such that, the grooves collectively form a circular passageway for a lance to pass therethrough, the rotation of the pair drive gears advances or retracts the lance according to the direction of the rotation.

28. (canceled)

29. (canceled)

30. The apparatus of claim 1 wherein, the flange comprises the flange of a heat exchanger.

31. The apparatus of claim 1 wherein, the at least one guide comprises two parallel and vertically-aligned guides.

32-35. (canceled)

36. The apparatus of claim 1 wherein, the flange is a part of a flange stand comprising a stand for placement on the ground, the flange attached to the stand; the flange stand placed near the tube bundle such that, the face of the tube bundle is within the circular opening of the annular flange.

37. The apparatus of claim 36 wherein, the stand comprises a chair-like frame member with the flange secured on top of the exemplary chair's backrest.
